(19) United States
(12) Patent Application Publication
(10) Pub. No.: US 2022/0163652 A1
(43) Pub. Date: May 26, 2022

(54) FMCW-BASED VR ENVIRONMENT INTERACTION SYSTEM AND METHOD

(71) Applicant: NANJING UNIVERSITY OF AERONAUTICS AND ASTRONAUTICS, Nanjing (CN)

(72) Inventors: Yanchao ZHAO, Nanjing (CN); Wenhao JIANG, Nanjing (CN); Si LI, Nanjing (CN)

(21) Appl. No.: 17/665,581

(22) Filed: Feb. 6, 2022

Related U.S. Application Data
(63) Continuation of application No. PCT/CN2020/130081, filed on Nov. 19, 2020.

(30) Foreign Application Priority Data
Dec. 18, 2019 (CN) 201911305425.2

(51) Int. Cl. G01S 13/34; G01S 13/36; G01S 13/48

(52) U.S. Cl. CPC G01S 13/343; G06F 3/014; G01S 13/48; G01S 13/36

(57) ABSTRACT

A frequency modulated continuous wave (FMCW)-based virtual reality (VR) environment interaction system and method are provided. Signal generators (S1, S2, S3) are provided to transmit FMCW signals; a glove is worn on a hand by a user; and multiple signal receiving nodes (H) are provided on the glove and configured to receive the FMCW signals. When the signal receiving nodes (H) receive the FMCW signals, one-dimensional distances are measured by means of FMCW technique; after the distances are measured, positions of the signal receiving nodes (H) in a coordinate system of the signal generators (S1, S2, S3) are calculated; a change in a position of the hand that wears the glove is tracked by means of changes in the positions of the signal receiving nodes (H); and a VR interaction is performed by outputting a change in a coordinate point matrix formed by the signal receiving nodes (H).

### CROSS REFERENCE TO RELATED APPLICATION(S)

The present application is a continuation of copending international application No. PCT/CN2020/130081, filed on Nov. 19, 2020, which claims the benefit of priority from Chinese Patent Application No. 201911305425.2, filed with the China National Intellectual Property Administration on Dec. 18, 2019, and entitled “FREQUENCY MODULATED CONTINUOUS WAVE (FMCW)-BASED VIRTUAL REALITY (VR) ENVIRONMENT INTERACTION SYSTEM AND METHOD”, each of which is incorporated herein by reference in its entirety.

### TECHNICAL FIELD

The present disclosure relates to a man-machine interaction system in wireless sensing networks, and in particular to a frequency modulated continuous wave (FMCW)-based virtual reality (VR) environment interaction system and method.

### BACKGROUND ART

FMCW technique is mainly used for high-precision radar ranging. Based on the FMCW technique, FMCW signals are transmitted mainly through a signal generator, and then received through a receiver, and time of flight (TOF) of sound is obtained by calculating frequency difference between the transmitted signals and the current received signals, and distance between a signal generator and a signal receiving node is calculated by multiplying the TOF by a signal propagation velocity.

It is expected that this technique can provide a better way for VR devices to interact with humans, with its capacity to obtain high-precision distance.

At present, there are two main ways of man-machine interaction in a VR system:

(1) a VR handle is used to interact by rocking a joystick or clicking a button; however, this way cannot bring a sense of reality in a virtual environment, and thus fails to give users a realistic sense of interaction; and

(2) as a result, a VR glove is produced to capture hand movements of users, most of which, however, directly measure relative movement of hands in space by inertial sensors, acceleration sensors or by other means. Problems with these sensors lie in that: such sensors cannot determine exact locations of objects in space, cheap sensors cannot measure precise position changes, while high-precision sensors are too expensive to afford.

### SUMMARY

An object of the present disclosure is to provide an FMCW-based VR environment interaction system and method. Using FMCW technique to measure distances between multiple signal generators and signal receiving nodes, to obtain coordinates of the nodes in space, and track movement of the nodes in space so as to track movement of hands in space, thereby providing man-machine interactions for VR systems.

Technical solutions of the present disclosure are as follows:

An FMCW-based VR environment interaction system, includes a glove, signal receiving nodes and signal generators, where

there are multiple signal generators provided to transmit FMCW signals;

the glove is worn on a hand of a user;

there are multiple signal receiving nodes provided on the glove and configured to receive the FMCW signals transmitted by the signal generators; and

when the signal receiving nodes receive the FMCW signals, one-dimensional distances, namely, distances between the signal receiving nodes and the signal generators are measured by means of FMCW technique; after the one-dimensional distances are measured, positions of the signal receiving nodes in a coordinate system of the signal generators are calculated; a change in a position of the hand that wears the glove is tracked by means of changes in the positions of the signal receiving nodes; and a VR interaction is performed by outputting a change in a coordinate point matrix formed by the signal receiving nodes.

In some embodiments, the FMCW signals are frequency division FMCW signals, and include three or more frequency division FMCW signals with different bands; and for each of the frequency division FMCW signals, a frequency sweep bandwidth is B, a modulation frequency sweep period is T, and there are frequency intervals between frequency bands of different frequency division FMCW signals.

In some embodiments, the multiple signal receiving nodes are disposed on fingers, palm and hand back of the glove.

The present disclosure further provides a VR environment interaction method based on the foregoing system, the method includes the following steps:

FMCW-based ranging step for: one-dimensional distances are measured, namely, distances between signal receiving nodes and signal generators by means of FMCW technique;

distance-based coordinate positioning step for: after the one-dimensional distances are measured, the positions of the signal receiving nodes in the coordinate system are calculated;

coordinate-based hand tracking step for: the change in the position of the hand that wears the glove is tracked according to the changes in the positions of the signal receiving nodes; and

VR interaction step for: the VR environment interaction is performed through the changes in an output coordinate point matrix.

In some embodiments, in FMCW-based ranging step, when the signal receiving nodes receive the FMCW signals, frequency differences between receiving frequencies of the signal receiving nodes and transmission frequencies of the signal generators at a current moment are calculated, TOFs are obtained according to frequency change curves, and flight distances are obtained by multiplying the TOFs by a signal propagation velocity and the flight distances are used as distances between the signal receiving nodes and the signal generators.

In some embodiments, a method for calculating a distance between one signal receiving node and one signal generator is as follows:

each FMCW signal change curve is represented as:

$$f ( t ) = \frac{B}{T} \times t + {f}_{0}$$

where B is the frequency sweep bandwidth, T is a modulation frequency sweep period, t is a time, and f₀ is an initial frequency of the frequency sweep bandwidth;

a transmitted signal is represented as:

F(t)=cos(2π×t×f(t))

received signals are represented as:

$$R ( t ) = {\sum }_{k = 1}^{N} cos ( 2 π \times t \times f ( t - Δ {t}_{k} ) )$$

where, Δtₖ represents signal delay of a certain one of multiple paths, with subscript k being any one of the multiple paths;

the frequency difference between the received signal and the transmitted signal at a same moment is obtained by the following equations:

$$I ( t ) = F ( t ) \times R ( t ) = cos ( 2 π \times t \times f ( t ) ) \times {\sum }_{k = 1}^{N} cos ( 2 π \times t \times f ( t - Δ {t}_{k} ) )$$

above equation is simplified with reference to the following trigonometric function:

$$cos ( α ) \times cos ( β ) = \frac{cos ( α + β ) + cos ( α - β )}{2}$$

cos(α−β) is obtained by filtering out high-frequency parts, such that the frequency difference is obtained;

$$I ( t ) = {\sum }_{k = 1}^{N} cos ( 2 π \times t \times Δ {f}_{k} )$$

where Δfₖ represents a frequency difference between a signal of the received signals which runs along the certain one of multiple paths and a current transmitted signal;

where in presence of a lot of multipath interferences, a direct wave has shorter flight path and larger signal energy, and therefore, from signal point of view, a signal that has strongest energy and smallest frequency difference is direct wave signal;

by converting a frequency difference of the direct wave signals into a time difference, and multiplying the time difference by the signal propagation velocity, the distance between the signal generator and the signal receiving node is obtained:

$$D = V * ( \frac{Δ f}{B} * T ) = V * t$$

where Δf represents the frequency difference between the direct wave signal and the transmitted signal, and V represents the signal propagation velocity; and

through above method, distances between the signal receiving node and other signal generators are obtained by using a bandpass filter with different filtering frequency bands.

In some embodiments, a method for calculating a distance between one signal receiving node and one signal generator is as follows:

a transmitted signal is represented as:

F(t)=cos(2π×t×f(t))

where

$$f ( t ) = \frac{B}{2 T} \times t + {f}_{0} ,$$

and B is the frequency sweep bandwidth, T is a modulation frequency sweep period, t is a time, and f₀ is an initial frequency of the frequency sweep bandwidth;

received signals are represented as:

$$R ( t ) = {\sum }_{k = 1}^{N} cos ( 2 π \times t \times f ( t - Δ {t}_{k} ) )$$

where, Δtₖ represents signal delay of a certain one of multiple paths, with subscript k being any one of the multiple paths;

the frequency difference between the received signal and the transmitted signal at a same moment is obtained by the following equations:

$$I ( t ) = F ( t ) \times R ( t ) = cos ( 2 π \times t \times f ( t ) ) \times {\sum }_{k = 1}^{N} cos ( 2 π \times t \times f ( t - Δ {t}_{k} ) )$$

above equation is simplified with reference to the following trigonometric function:

$$cos ( α ) \times cos ( β ) = \frac{cos ( α + β ) + cos ( α - β )}{2}$$

cos(α−β) is obtained by filtering out high-frequency parts, such that the frequency difference is obtained;

$$I ( t ) = {\sum }_{k = 1}^{N} cos ( 2 π \times t \times Δ {f}_{k} )$$

where Δfₖ represents a frequency difference between a signal of the received signals which runs along the certain one of multiple paths and a current transmitted signal;

where in presence of a lot of multipath interferences, a direct wave has shorter flight path and larger signal energy, and therefore, from signal point of view, a signal that has strongest energy and smallest frequency difference is direct wave signal;

by converting a frequency difference of the direct wave signals into a time difference, and multiplying the time difference by the signal propagation velocity, the distance between the signal generator and the signal receiving node is obtained:

$$D = V * ( \frac{Δ f}{B} * T ) = V * t$$

where Δf represents the frequency difference between the direct wave signal and the transmitted signal, and V represents the signal propagation velocity; and

through above method, distances between the signal receiving node and other signal generators are obtained by using a bandpass filter with different filtering frequency bands.

In some embodiments, in the distance-based coordinate positioning step, through selecting different frequency bands of multiple different signal generators, one signal receiving node can receive multiple signals with different frequency bands from the different signal generators, and the distances between the signal receiving node and the signal generators at different positions in space are calculated, and coordinates of the signal receiving node in the coordinate system of the signal generators are determined based on the positions of the signal generators.

In some embodiments, a method for determining the coordinates of the signal receiving node in the coordinate system of the signal generators is as follows:

firstly, relative positions of the three or more signal generators that are not on a same straight line are known, and the coordinate system is established by using positions of these signal generators; three signal generators (S₁, S₂, S₃) are located on three axes of the coordinate system with coordinates being (x₀,0,0), (0,z₀,0), and (0,0,y₀), respectively, a signal receiving node H is located in the coordinate system, it is known that distances between the node H and the signal generators are D₁, D₂, and D₃, respectively, and coordinates of the node H are solved by the following equations:

$$\{ \begin{matrix}{D}_{1} = \sqrt{{( x - {x}_{0} )}^{2} + {y}^{2} + {z}^{2}} \\ {D}_{2} = \sqrt{{x}^{2} + {y}^{2} + {( z - {z}_{0} )}^{2}} \\ {D}_{3} = \sqrt{{x}^{2} + {( y - {y}_{0} )}^{2} + {z}^{2}}\end{matrix}$$

after solving the above equations, two solutions are obtained, if three signal generating nodes are used, an initialization position is needed, during booting up use, the user is indicated to place the glove at the initialization position, then two coordinate solutions are obtained, and upon comparison of a result of current moment with that of previous moment, coordinate points with less moving distance are selected as result points;

when four signal generators are used in the system, and no three signal generators among the four signal generators is positioned on a same straight line, by simultaneous solving of four equations, only one solution, which is an exact coordinate of the signal receiving node on the coordinate system, can be obtained; and

through above method, coordinates of the other signal receiving nodes in space are solved.

In some embodiments, in coordinate-based hand tracking step, multiple signal receiving nodes are disposed on the glove, a coordinate of each of the signal receiving nodes in the coordinate system of the signal generators are calculated, and the coordinates of the multiple signal receiving nodes form a node array in the coordinate system, which represents a shape of the hand and is used to track the hand, different gestures of the hand can show different shape changes of the array.

In some embodiments, in VR interaction step, the coordinate matrix formed by the signal receiving nodes is obtained, and gestures are fitted through changes in the coordinate matrix, thereby providing an interaction mode in line with using habits of the hand for the VR environment interaction system.

Compared with the conventional art, the present disclosure has the following advantages.

According to the present disclosure, by using FMCW technique to measure movement tracks of signal receiving nodes disposed in a glove, the movement of the hand is measured; and then exact positions of sensors in space can be determined, and an accurate interaction with more auxiliary VR objects is made possible, thereby providing a more realistic man-machine interaction mode for the VR system. By improving the sampling rate, the present disclosure can correspondingly improve the accuracy of distance recognition.

### BRIEF DESCRIPTION OF THE DRAWINGS

The present disclosure will be explained in detail with reference to accompanying drawings:

FIG. 1 is a flowchart illustrating operation of an individual signal receiving node;

FIG. 2 is a schematic diagram showing principle of FMCW;

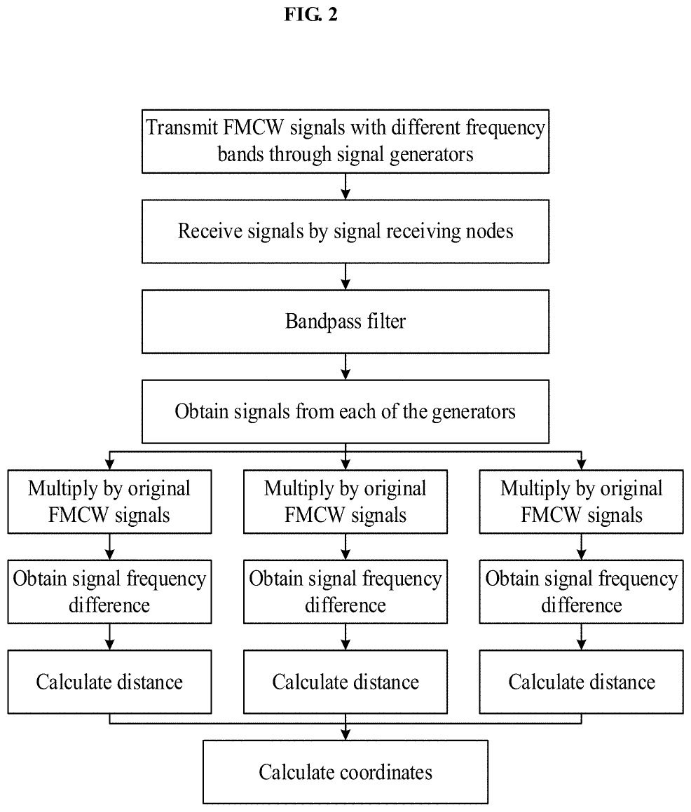

FIG. 3 is a schematic diagram of a coordinate system; and

FIG. 4 is a simple schematic diagram of signal receiving nodes on a glove.

### DETAILED DESCRIPTION OF THE EMBODIMENTS

Technical solutions in embodiments of the present disclosure will be described in detail below with reference to accompanying drawings in the embodiments of the present disclosure. Apparently, the described embodiments are merely a part rather than all of the embodiments of the present disclosure. All other embodiments derived from the embodiments in the present disclosure by a person of ordinary skills in the art without creative work shall fall within protection scope of the present disclosure.

A frequency modulated continuous wave (FMCW)-based VR environment interaction system includes a glove, signal receiving nodes and signal generators.

There are multiple signal generators configured to transmit FMCW signals;

the glove is worn on a hand of a user; and

there are multiple signal receiving nodes disposed on the glove and configured to receive the FMCW signals transmitted by the signal generators.

Frequency division FMCW signals are mainly used in the present disclosure, which include three or more FMCW signals with different bands; and for each of the frequency division FMCW signals, a frequency sweep bandwidth is B, a modulation frequency sweep period is T, and initial frequency is f₁, f₂, and f₃. There is a frequency interval between frequency bands of frequency division FMCW signals. For example, if a first frequency band is [f₁, f₁+B], a second frequency band is [f₂, f₂+B], and a third frequency band is [f₃, f₃+B], and it is assumed that the frequency interval is f′, f₂=f₁+B+f′, and f₃=f₂+B+f′. Such intervals between frequency bands can help subsequent filters to separate signals between different frequency bands.

When a signal receiving node receives a FMCW signal, one-dimensional distance, namely, a distance between the signal receiving node and a signal generator is measured by means of FMCW technique. After the one-dimensional distance is measured, positions of the signal receiving nodes in a coordinate system of the signal generators are calculated. A change in a position of the hand that wears the glove is tracked by means of changes in the positions of the signal receiving nodes, and a VR interaction is achieved by outputting a change in a coordinate point matrix formed by the signal receiving node.

A VR environment interaction method based on the foregoing system, the method includes the following steps.

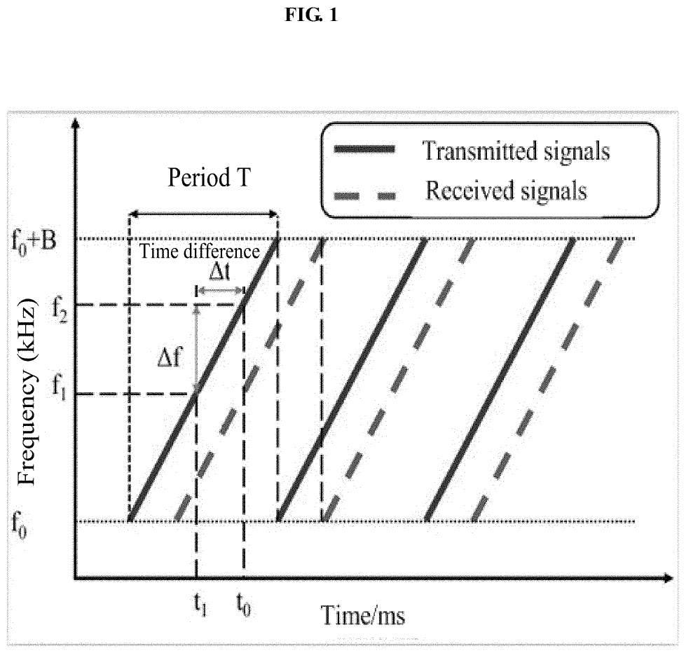

In step (1) of FMCW-based ranging, one-dimensional distances, namely, distances between signal receiving nodes and signal generators are measured by means of FMCW technique. As shown in FIG. 1, a FMCW signal is transmitted through a signal generator, and then the FMCW signals is received through a signal receiving node. When the signal receiving node receive the FMCW signal, a frequency difference between a receiving frequency of the signal receiving node and a transmission frequency of the signal generator at a current moment is calculated. Then, a time of flight (FOT) is obtained according to a frequency change curve, and a flight distance is obtained by multiplying the TOF by a signal propagation velocity and the flight distance is used as the distance between the signal receiving node and the signal generator;

An FMCW signal change curve is represented as:

$$f ( t ) = \frac{B}{T} \times t + {f}_{0}$$

where B is a frequency sweep bandwidth, T is a modulation frequency sweep period, t is a time, and f₀ is an initial frequency of the frequency sweep bandwidth.

The transmitted signal is represented as:

F(t)=cos(2π×t×f(t))

In other embodiments, the transmitted signal is represented as:

F(t)=cos(2π×t×f(t))

where

$$f ( t ) = \frac{B}{2 T} \times t + {f}_{0} ,$$

and B is a frequency sweep bandwidth, T is a modulation frequency sweep period, t is a time, and f₀ is an initial frequency of the frequency sweep bandwidth.

The received signals are represented as:

$$R ( t ) = {\sum }_{k = 1}^{N} cos ( 2 π \times t \times f ( t - Δ {t}_{k} ) ) ,$$

where, Δtₖ represents a signal delay for a certain one of multiple paths with subscript k being any one of the multiple paths.

The frequency difference between the received signal and the transmitted signals at a same moment is obtained by the following methods:

$$I ( t ) = F ( t ) \times R ( t ) = cos ( 2 π \times t \times f ( t ) ) \times {\sum }_{k = 1}^{N} cos ( 2 π \times t \times f ( t - Δ {t}_{k} ) )$$

The above formula is simplified with reference to the following trigonometric function:

$$cos ( α ) \times cos ( β ) = \frac{cos ( α + β ) + cos ( α - β )}{2}$$

cos(α−β) is obtained by filtering out high-frequency parts, such that the frequency difference is obtained;

$$I ( t ) = {\sum }_{k = 1}^{N} cos ( 2 π \times t \times Δ {f}_{k} )$$

where Δfₖ represents the frequency difference between a signal of the received signals which runs along the certain one of the multiple paths and the current transmitted signal.

In the presence of a lot of multipath interference, a direct wave has shorter flight path and larger signal energy, and therefore, from the signal point of view, a signal that has the strongest energy and the smallest frequency difference is a direct wave signal.

By converting the frequency difference of the direct wave signal into a time difference, and then multiplying the time difference by a signal propagation velocity, the distance between the signal generator and the signal receiving node is obtained:

$$D = V * ( \frac{Δ f}{B} * T ) = V * t$$

where Δf represents the frequency difference between the direct wave signal and the transmitted signal, and V represents the signal propagation velocity.

Likewise, the distances between the signal receiving node and other signal generators are obtained by using a bandpass filter with different filtering frequency bands.

In step (2) of distance-based coordinate positioning, after the one-dimensional distances are measured, the position of the signal receiving node in a coordinate system is calculated. Through the selecting different frequency bands for multiple different signal generators, a signal receiving node can receive multiple signals with different frequency bands from different signal generators. In this way, the distances between the signal receiving node and the signal generators at different positions in space are calculated, and a coordinate of the signal receiving node in the coordinate system of the signal generators are determined based on the positions of the signal generators.

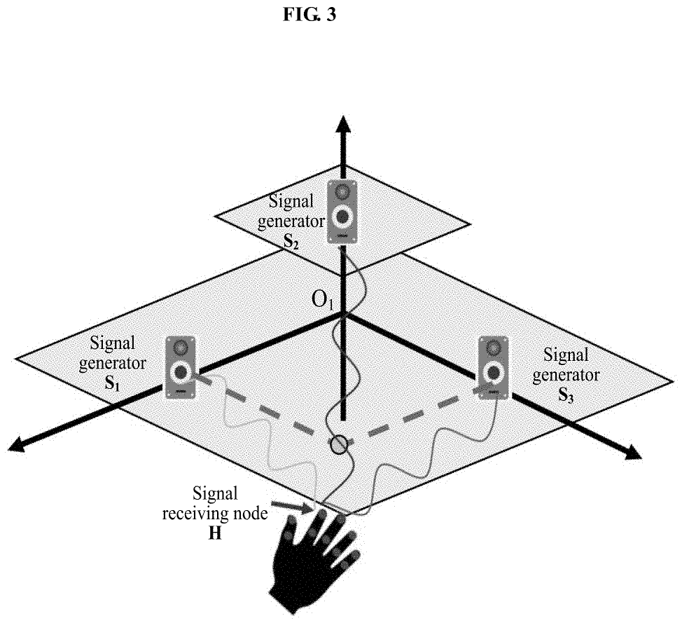

Firstly, relative positions of the multiple (three or more) signal generators that are not on a same straight line are known, and a coordinate system is established by using the positions of these signal generators. In a simple coordinate system as shown in FIG. 3, the three signal generators (S₁, S₂, S₃) are located on three axes of the coordinate system with coordinates being (x₀,0,0), (0,z₀,0), and (0,0,y₀), respectively. A signal receiving node H is located in the coordinate system, it is known that the distances between the node H and the signal generators are D₁, D₂, and D₃, respectively, and coordinates of the node H are solved by the following equations:

$$\{ \begin{matrix}{D}_{1} = \sqrt{{( x - {x}_{0} )}^{2} + {y}^{2} + {z}^{2}} \\ {D}_{2} = \sqrt{{x}^{2} + {y}^{2} + {( z - {z}_{0} )}^{2}} \\ {D}_{3} = \sqrt{{x}^{2} + {( y - {y}_{0} )}^{2} + {z}^{2}}\end{matrix}$$

After solving the above equations, two solutions are obtained. In the case, if three signal generating nodes are used, an initialization position is needed, during booting up for use, the user is indicated to place the glove at the initialization position, then two coordinate solutions are obtained. Upon comparison of a result of current moment with that of previous moment, coordinate points with less moving distance are selected as result points;

However, when four signal generators are used in the system, and there are no three signal generators among the four signal generators on the same straight line, by simultaneous solving of four equations, only one solution, namely, the exact coordinates of the signal receiving node on the coordinate system, can be obtained.

Likewise, coordinates of all the other signal receiving nodes in space are solved;

In step (3) of coordinate-based hand tracking, the change in a position of the hand that wears the glove is tracked through the change in the positions of the signal receiving nodes. Multiple signal receiving nodes are disposed on the glove, a coordinate of each of the signal receiving nodes in the coordinate system of the signal generators are calculated, and the coordinates of the multiple signal receiving nodes form a node array in the coordinate system, which represents a shape of the hand and is used to track the hand, different gestures of the hand can show different changes in shape of the array;

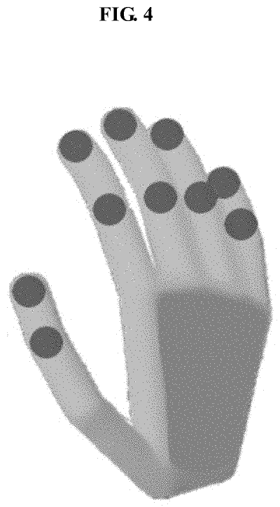

To solve the coordinate positions of all the signal receiving nodes at the same time, each signal receiving node corresponds to one corresponding calculation thread, and coordinate positions of the signal receiving nodes in the coordinate system are calculated simultaneously. For each calculation, calculation threads corresponding to respective nodes can output coordinate positions of current nodes at the same time. After coordinates are solved, the coordinate points of all the signal receiving nodes in the coordinate system of the signal generators are obtained. These coordinate points form an array, and the change in the position of the array in the coordinate system represents the change in the position of the glove in the coordinate system, which also represents the movement of the hand that wears the glove in the coordinate system. In a simple schematic diagram of nodes on the glove as shown in FIG. 4, when the nodes are more densely distributed, movement of the hand will be captured in more detail. FIG. 4 shows a simple arrangement of nodes used by the glove to track finger movement. When finer and more accurate movement needs to be tracked, it is possible to dispose more signal receiving nodes on the fingers, and meanwhile, corresponding nodes can also be disposed on the palm and back of the hand.

In step (4) of VR interaction, a VR environment interaction is provided through the change in a coordinate point matrix outputted. A coordinate matrix formed by the signal receiving nodes is obtained, and gestures is fitted through the change in the coordinate matrix, thereby providing an interaction mode in line with using habits of the hand for the VR interaction environment system.

### Embodiment

In the present disclosure, preliminary realization and verification are carried out with existing commercial microphones (microphones) used as signal receiving nodes, and commercial loudspeakers as signal generators. The frequency response curves of microphones and loudspeakers both cover ultrasonic part, and sampling rate of 48 kHz is used for sampling. After recording signals by using the microphones, signals of three channels are obtained by bandpass filtering. By multiplying the signals by original signals, distances between the microphone nodes and the corresponding loudspeakers are analyzed, and ultimately, coordinates are calculated by combining three distances corresponding to the three channels. By means of the coordinate matrix, the hand that wears the glove is tracked.

The embodiments of the present disclosure are described in detail above with reference to the accompanying drawings, but the present disclosure is not limited to the above embodiments. Within the knowledge of a person of ordinary skills in the art, various variations can also be made without departing from the spirit of the present disclosure.

What is claimed is:

1. A frequency modulated continuous wave (FMCW)-based virtual reality (VR) environment interaction system, comprising a glove, signal receiving nodes and signal generators, wherein
a plurality of signal generators are provided to transmit FMCW signals;
the glove is worn on a hand of a user;
a plurality of signal receiving nodes are provide on the glove and are configured to receive the FMCW signals transmitted by the signal generators; and
when the signal receiving nodes receive the FMCW signals, one-dimensional distances, which are distances between the signal receiving nodes and the signal generators are measured by means of FMCW technique; after the one-dimensional distances are measured, positions of the signal receiving nodes in a coordinate system of the signal generators are calculated; a change in a position of the hand that wears the glove is tracked by means of changes in the positions of the signal receiving nodes; and the VR environment interaction is performed by outputting a change in a coordinate point matrix formed by the signal receiving nodes.

2. The FMCW-based VR environment interaction system according to claim 1, wherein the FMCW signals are frequency division FMCW signals, and comprise three or more frequency division FMCW signals with different bands; and for each of the frequency division FMCW signals, a frequency sweep bandwidth is B, a modulation frequency sweep period is T, and frequency bands of different frequency division FMCW signals are spaced apart at a frequency interval.

3. The FMCW-based VR environment interaction system according to claim 1, wherein the plurality of signal receiving nodes are disposed on fingers, palm and hand back of the glove.

4. A VR environment interaction method performed by FMCW-based VR environment interaction system, the system comprising a glove, signal receiving nodes and signal generators, wherein
a plurality of signal generators are provided to transmit FMCW signals;
the glove is worn on a hand of a user;
a plurality of signal receiving nodes are provide on the glove and are configured to receive the FMCW signals transmitted by the signal generators; and
when the signal receiving nodes receive the FMCW signals, one-dimensional distances, which are distances between the signal receiving nodes and the signal generators are measured by means of FMCW technique; after the one-dimensional distances are measured, positions of the signal receiving nodes in a coordinate system of the signal generators are calculated; a change in a position of the hand that wears the glove is tracked by means of changes in the positions of the signal receiving nodes; and the VR environment interaction is performed by outputting a change in a coordinate point matrix formed by the signal receiving nodes;
the method comprising following steps:
FMCW-based ranging step for measuring one-dimensional distances, which are distances between signal receiving nodes and signal generators by means of FMCW technique;
distance-based coordinate positioning step for calculating the positions of the signal receiving nodes in the coordinate system after the one-dimensional distances are measured;
coordinate-based hand tracking step for tracking the change in the position of the hand that wears the glove according to the changes in the positions of the signal receiving nodes; and
VR interaction step for performing the VR environment interaction through the changes in an output coordinate point matrix.

5. The method according to claim 4, further comprising: in FMCW-based ranging step, when the signal receiving nodes receive the FMCW signals, calculating frequency differences between receiving frequencies of the signal receiving nodes and transmission frequencies of the signal generators at a current moment, obtaining time of flights (TOFs) according to frequency change curves, and obtaining flight distances, which are distances between the signal receiving nodes and the signal generators, by multiplying the TOFs by a signal propagation velocity.

6. The method according to claim 5, wherein a method for calculating a distance between one signal receiving node and one signal generator is as follows:
each FMCW signal change curve is represented as:
$$f ( t ) = \frac{B}{T} \times t + {f}_{0}$$
wherein B is the frequency sweep bandwidth, T is a modulation frequency sweep period, t is a time, and f₀ is an initial frequency of the frequency sweep bandwidth;
a transmitted signal is represented as:
F(t)=cos(2π×t×f(t))
received signals are represented as:
$$R ( t ) = {\sum }_{k = 1}^{N} cos ( 2 π \times t \times f ( t - Δ {t}_{k} ) )$$
wherein, Δtₖ represents signal delay for a certain one of multiple paths with subscript k being any one of the multiple paths;
the frequency difference between the received signal and the transmitted signal at a same moment is obtained by following equations:
$$I ( t ) = F ( t ) \times R ( t ) = cos ( 2 π \times t \times f ( t ) ) \times {\sum }_{k = 1}^{N} cos ( 2 π \times t \times f ( t - Δ {t}_{k} ) )$$
above equation is simplified with reference to following trigonometric function:
$$cos ( α ) \times cos ( β ) = \frac{cos ( α + β ) + cos ( α - β )}{2}$$
cos(α−β) is obtained by filtering out high-frequency parts, such that the frequency difference is obtained;
$$I ( t ) = {\sum }_{k = 1}^{N} cos ( 2 π \times t \times Δ {f}_{k} )$$
wherein Δfₖ represents a frequency difference between a signal of the received signals which runs along the certain one of multiple paths and a current transmitted signal;
wherein in presence of a lot of multipath interferences, a direct wave has shorter flight path and larger signal energy, and therefore, from signal point of view, a signal that has strongest energy and smallest frequency difference is direct wave signal;
by converting a frequency difference of the direct wave signal into a time difference, and multiplying the time difference by the signal propagation velocity, the distance between the signal generator and the signal receiving node is obtained:
$$D = V * ( \frac{Δ f}{B} * T ) = V * t$$
wherein Δf represents the frequency difference between the direct wave signal and the transmitted signal, and V represents the signal propagation velocity; and
through above method, distances between the signal receiving node and other signal generators are obtained by using a bandpass filter with different filtering frequency bands.

7. The method according to claim 5, wherein a method for calculating a distance between one signal receiving node and one signal generator is as follows:
a transmitted signal is represented as:
F(t)=cos(2π×t×f(t))
wherein
$$f ( t ) = \frac{B}{2 T} \times t + {f}_{0} ,$$
and B is the frequency sweep bandwidth, T is a modulation frequency sweep period, t is a time, and f₀ is an initial frequency of the frequency sweep bandwidth;
received signals are represented as:
$$R ( t ) = {\sum }_{k = 1}^{N} cos ( 2 π \times t \times f ( t - Δ {t}_{k} ) )$$
wherein, Δtₖ represents signal delay for a certain one of multiple paths with subscript k being any one of the multiple paths;
the frequency difference between the received signal and the transmitted signal at a same moment is obtained by following equations:
$$I ( t ) = F ( t ) \times R ( t ) = cos ( 2 π \times t \times f ( t ) ) \times {\sum }_{k = 1}^{N} cos ( 2 π \times t \times f ( t - Δ {t}_{k} ) )$$
above equation is simplified with reference to following trigonometric function:
$$cos ( α ) \times cos ( β ) = \frac{cos ( α + β ) + cos ( α - β )}{2}$$
cos(α−β) is obtained by filtering out high-frequency parts, such that the frequency difference is obtained;
$$I ( t ) = {\sum }_{k = 1}^{N} cos ( 2 π \times t \times Δ {f}_{k} )$$
wherein Δfₖ represents a frequency difference between a signal of the received signals which runs along the certain one of multiple paths and a current transmitted signal;
wherein in presence of a lot of multipath interferences, a direct wave has shorter flight path and larger signal energy, and therefore, from signal point of view, a signal that has strongest energy and smallest frequency difference is direct wave signal;
by converting a frequency difference of the direct wave signal into a time difference, and multiplying the time difference by the signal propagation velocity, the distance between the signal generator and the signal receiving node is obtained:
$$D = V * ( \frac{Δ f}{B} * T ) = V * t$$
wherein Δf represents the frequency difference between the direct wave signal and the transmitted signal, and V represents the signal propagation velocity; and
through above method, distances between the signal receiving node and other signal generators are obtained by using a bandpass filter with different filtering frequency bands.

8. The method according to claim 4, wherein in the distance-based coordinate positioning step, through selecting different frequency bands for a plurality of different signal generators, one signal receiving node receive a plurality of signals with different frequency bands from the different signal generators, and the distances between the signal receiving node and the signal generators at different positions in space are calculated, and a coordinate of the signal receiving node in the coordinate system of the signal generators are determined based on the positions of the signal generators.

9. The method according to claim 8, wherein a method for determining the coordinate of the signal receiving node in the coordinate system of the signal generators is as follows:
firstly, relative positions of the three or more signal generators that are not on a same straight line are known, and the coordinate system is established by using positions of these signal generators; three signal generators (S₁, S₂, S₃) are located on three axes of the coordinate system with coordinates being (x₀,0,0), (0,z₀,0), and (0,0,y₀), respectively, a signal receiving node H is located in the coordinate system, distances between the node H and the signal generators are D₁, D₂, and D₃ respectively which are known, and a coordinate of the node H are solved by following equations:
$$\{ \begin{matrix}{D}_{1} = \sqrt{{( x - {x}_{0} )}^{2} + {y}^{2} + {z}^{2}} \\ {D}_{2} = \sqrt{{x}^{2} + {y}^{2} + {( z - {z}_{0} )}^{2}} \\ {D}_{3} = \sqrt{{x}^{2} + {( y - {y}_{0} )}^{2} + {z}^{2}}\end{matrix}$$
after solving the above equations, two solutions are obtained, if three signal generating nodes are used, an initialization position is needed, during booting up for use, the user is indicated to place the glove at the initialization position, then two coordinate solutions are obtained, and upon comparison of a result of current moment with that of previous moment, coordinate points with less moving distance are selected as result points;
when four signal generators are used in the system, and no three signal generators among the four signal generators is positioned on a same straight line, by simultaneous solving of four equations, only one solution, which is an exact coordinate of the signal receiving node on the coordinate system, is obtained; and
through above method, coordinates of the other signal receiving nodes in space are solved.

10. The method according to claim 4, wherein in coordinate-based hand tracking step, a plurality of signal receiving nodes are disposed on the glove, a coordinate of each of the signal receiving nodes in the coordinate system of the signal generators are calculated, and coordinates of the plurality of the signal receiving nodes form a node array in the coordinate system, which represents a shape of the hand and is used to track the hand, different gestures of the hand show different shape changes of the array.

11. The method according to claim 4, wherein in VR interaction step, the coordinate matrix formed by the signal receiving nodes is obtained, and gestures are fitted through changes in the coordinate matrix, thereby providing an interaction mode in line with using habits of the hand for the VR environment interaction system.
